(19) United States
(12) Patent Application Publication
(10) Pub. No.: US 2024/0016321 A1
(43) Pub. Date: Jan. 18, 2024

(54) TEABAG HOLDER ALLOWING ADJUSTABLE IMMERSION DEPTH

(71) Applicant: Jeanne M. Horvath, Rochester, NY (US)

(72) Inventor: Jeanne M. Horvath, Rochester, NY (US)

(21) Appl. No.: 18/334,525

(22) Filed: Jun. 14, 2023

Related U.S. Application Data
(60) Provisional application No. 63/388,345, filed on Jul. 12, 2022.

(51) Int. Cl. A47G 19/16; A47J 31/06

(52) U.S. Cl. CPC A47G 19/16; A47J 31/0636

(57) ABSTRACT

An apparatus for steeping tea in a vessel, has a clamping member that is configured to releasably grasp an edge of a tea filter bag and a weighting member weighing more than the clamping member. A strand of beads has a first end coupled to the clamping member and a second end, opposite the first end, coupled to the weighting member. The strand of beads has a number of beads joined to each other by a metal linkage, wherein the strand of beads is configured to fold over a lip of the vessel to provide at least a first detent position for supporting the tea filter bag at a first immersion distance from the fold lip, and a second detent position for supporting the tea filter bag at a second immersion distance from the fold lip.

Reference is made to, and priority is claimed from, commonly assigned U.S. Ser. No. 63/388,345, filed as a provisional patent application on 12 Jul. 2022, entitled “TEABAG HOLDER ALLOWING ADJUSTABLE IMMERSION DEPTH” in the name of Jeanne M. Horvath, incorporated herein in its entirety.

### TECHNICAL FIELD

The present disclosure generally relates to beverage preparation materials and more particularly relates to a holder for steeping a teabag.

### BACKGROUND ART

Tea drinkers have various preferences that relate not only to types of tea, but also to how the tea itself is prepared, packaged, steeped, and enjoyed. For mass market consumption, commercially bagged tea is often packaged in a porous filter bag that is attached to a labeled tab by a string that enables immersion and removal of the teabag without the need for other holders or utensils. Many types of tea, however, have simper packaging that can change procedures for tea infusion. Herbal teas, in particular, as well as other specialty teas, are often pre-packaged in a filter bag that lacks an accompanying string or tab for easy insertion for steeping or removal from the freshly brewed tea. Or, the tea itself may be sold in loose form, so that packing the tea leaves into a re-usable filter, capsule, or other porous container is a standard task for tea preparation, prior to infusion or steeping.

The tea is steeped in a cup or other vessel or container by immersing the filter bag or other package in hot water. For single-cup preparation, tea drinkers have various practices and preferences related, for example, to immersion timing and duration, to setting the depth of the tea filter bag within the cup or teapot during immersion, and for removing or retaining the teabag as the tea is consumed.

Various techniques have been used for controlling immersion depth during infusion. With commercial stringed tea filter bags, for example, the desired depth of immersion within a cup or teapot can be set, to at least some degree, by wrapping the string around a cup handle or by using a lid or other mechanism to temporarily pinch the string against the lip of the cup or to otherwise grasp the string in some way. Some types of re-usable immersion capsules have a linked chain with a hook or similar connector for teabag immersion and removal, providing the tea drinker with some ability to set immersion depth by adjusting chain length or loop length, for example.

However, the ability to set immersion depth within the cup or teapot is not available for many types of bagged teas that lack a connecting string. A further disadvantage to the consumer of bagged, unstrung teas relates to the added work of teabag removal, particularly when hot. In many cases, enjoying an herbal tea or other specialty tea requires removal of the spent teabag from a cup using a spoon or other table utensil.

Thus, it can be appreciated that there is an unmet need for a straightforward solution to steeping tea, allowing the teabag to be disposed at a desired depth, controllable according to user preference, and providing the capability for simpler removal of the spent teabag, without scalding the fingers, once the tea is steeped. In addition to these functional requirements, there are accompanying requirements inherent for utensils that come into or near contact with food, including use of appropriate materials to avoid rust or corrosion and to eliminate exposure to toxic substances, as well as suitability for thorough cleaning for re-use, ability to withstand damage from water at boiling temperatures, simplicity of use, etc.

Other desirable objectives, features, and advantages of the disclosed invention may occur or become apparent to those skilled in the art.

### SUMMARY

It is an object of the present disclosure to address the need for suspending a teabag or re-usable tea capsule at a desired immersion depth, controlled according to user preference, and variable from one user to the next. Embodiments of the present disclosure can provide a convenient re-usable utensil that allows the tea preparer to adjust the height position (or, equivalently, the immersion depth) for tea filter bags with or without connecting strings.

According to an embodiment of the present disclosure, there is provided an apparatus for steeping tea in a vessel, comprising:
(a) a clamping member that is configured to releasably grasp an edge of a tea filter bag;
(b) a weighting member weighing more than the clamping member; and
(c) a strand of beads having a first end coupled to the clamping member and a second end, opposite the first end, coupled to the weighting member, the strand of beads having a plurality of beads joined to each other by a metal linkage, wherein the strand of beads is configured to fold over a lip of the vessel to provide at least a first detent position for supporting the tea filter bag at a first immersion distance from the fold lip, and a second detent position for supporting the tea filter bag at a second immersion distance from the fold lip.

### BRIEF DESCRIPTION OF DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows two views of a holder for a tea filter bag according to an embodiment of the present disclosure, with the grasping clamp at alternate angles.

FIG. 2 shows a cutaway side view presentation of the holder for a teabag at different depth immersion positions.

FIG. 3 shows a side view of a teabag holder having a beaded strand formed using seed beads that are positioned between larger beads.

### DESCRIPTION OF EMBODIMENTS

Figures shown and described herein are provided in order to illustrate key principles of operation and fabrication for an optical apparatus according to various embodiments and a number of these figures are not drawn with intent to show actual size or scale. Some exaggeration may be necessary in order to emphasize basic structural relationships or principles of operation.

Where they are used, the terms “first”, “second”, “third”, and so on, do not necessarily denote any ordinal or priority relation, but are used for more clearly distinguishing one element or time interval from another. For example, except where it may be used to describe an ordered sequence, there are no fixed “first” or “second” elements in what is taught herein; these descriptors are merely used to clearly distinguish one element from another similar element in the context of the present disclosure.

With respect to teabag steeping, it can be appreciated that the concepts of “immersion depth” and height from the bottom of a vessel, although they relate to different ways of expressing or measuring how deeply the teabag is immersed in a cup, are equivalent for practical purposes. Because immersion depth has the added factor of varying according to the amount of fluid poured into the cup, the Applicant has described immersion depth herein, more simply, in terms of height of the teabag from the bottom of the cup. The tea drinker, meanwhile, may tend to think more in terms of how deeply the teabag is immersed within the fluid.

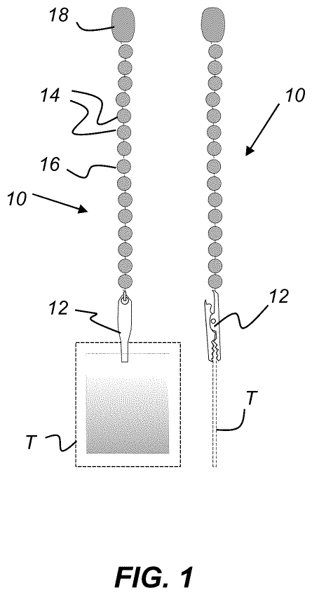

Referring to FIG. 1, there is shown a teabag holder 10 designed to address the need for suspension to allow immersion of a tea filter bag T at a desired depth and to allow removal of a teabag after brewing tea without the need for other utensils or risk of scalding. A releasable clamping member 12, such as a spring-actuated clamp like the familiar “alligator” clasp as shown, releasably grips the teabag T between opposing jaws for immersion and removal. The term “releasable” refers to the grasping operation of the clamp; clamping member 12 is manually attached to grasp, and to release, an edge portion of the tea filter bag T or, alternately, to grasp a ring, tab extension, or other extending portion of a reusable filter capsule. Clamping member 12 can be coupled to strand 16 using a wire or other metal linkage. Multiple tea filter bags T can also be supported, such as for brewing in a large teapot, for example. Multiple clamping members 12 can alternately be coupled to beaded strand 16.

Clamping member 12 can be formed from a durable, re-usable material that can be cleaned for re-use. A kitchen-safe metal such as stainless steel can be used, both for the body of the clamp and for any spring or other mechanical feature of the clamping member.

Clamping member 12 is coupled to a weight member 18 by a connecting strand 16 of beads 14 that extends between clamping member 12 and weight member 18. Beads 14 are typically joined by wire linkage, which can be a single wire that is strung through the bead, with the wire extending continuously through multiple beads 14, or with each bead 14 having a wire coupling, such as a wire loop, that links the bead 14 to its neighbor. Beading wire, such as stranded, silver-plated bead 0.46 mm stringing wire from Beadalon® (Valley Twp., PA, USA) can be used. Beading techniques using combinations of metal and bead materials are well-known to those skilled in the jewelry crafts. Bead-strands can include beads of different sizes, and may use seed beads, as noted subsequently.

Beads 14 can be formed from any of a number of types of material. Preferred are non-absorbent materials that are non-toxic, do not dissolve or change physical state in water and do not react chemically to water and are usable for food contact. Materials that can be used as beads 14 should be readily cleanable to allow re-use, such as glass, ceramics, various types of stones and gemstones, seashells, various solid, scratch-resistant polymers, and other naturally occurring materials, or synthetic materials, considered safe for food contact. Beads can be drilled or otherwise formed about a hollow core, provided in a form that can be strung together using beading techniques. Low heat conductance is an advantage for bead materials. Various types of non-corroding metal beads 14 could be used; however, these could tend to conduct heat that can scald an unwary tea-preparer.

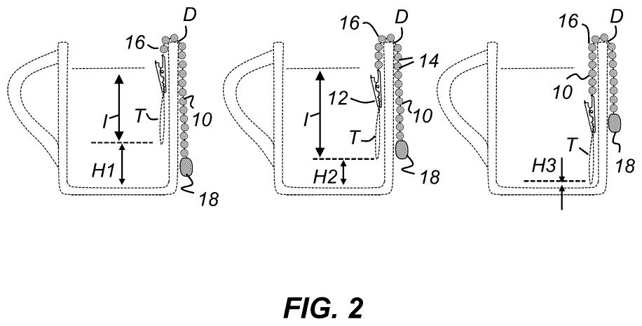

FIG. 2 presents a series of side views that show how teabag holder 10 enables tea steeping at an immersion depth I that is adjustable, selectable by the tea preparer. A cup is represented in cross-section using dashed lines. Filter bag T is suspended, with the bottom of bag T used as a reference measure. (As noted earlier, immersion depth involves the variable of fluid height; alternately, height from the bottom of the cup or vessel, on the other hand, is an inverse and simpler metric for description.) At left, the bottom of filter bag T is shown at a height H1 from the bottom of the cup. At center, filter bag T is deeper within the cup, suspended with its bottom portion at a lesser height H2. At right, filter bag T is suspended very near the bottom of the cup, at height H3.

As can be seen from FIG. 2, teabag holder 10 is configured so that beads 14 provide a series of mechanical stoppages or detents D that arrest and constrain upward or downward movement and stabilize the position of holder 10 at the lip of the cup or containing vessel used for steeping tea. This use of detents D allows the user/tea-preparer to measure out and restrain holder 10 in place at the needed length for achieving and maintaining the desired immersion depth throughout the steeping period. As is represented schematically in FIG. 2, the beads 14 can form detent D that allows filter bag T to be held in a stable position, at any number of desired immersion depths (for example, at one of heights H1, H2, H3.) Detents D are formed, for example, by leaving sufficient space within the strand of beads to allow a gap, at detent D, between a pair of adjacent beads when the strand is extended over the lip of a teacup.

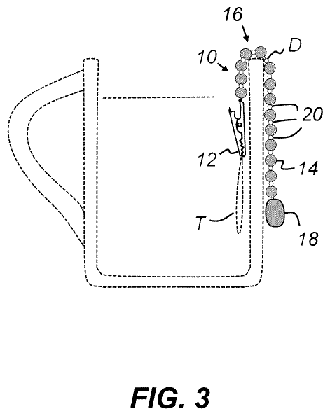

The use of seed beads is well known to those skilled in the beading and jewelry arts. As the term suggests, the seed bead is smaller than other bead types with which it may be used. Basically, the seed bead is an intermediary structure that provides a type of spacer and fills the gap between larger beads. The Applicant has found that the use of one or more seed beads in strand 16 can provide a fixed number of detents D and make some detents D more visible, such as at even increments along the strand 16. The side view of FIG. 3 shows an alternative beading arrangement using seed beads 20 between larger beads 14. By way of example only, the width dimension of the larger beads 14 can be at least 1.5 times the width dimension of the intermediary seed beads 20. By way of example, and not by limitation, for a strand of beads that are 10 mm in diameter, typical seed beads can be 3 mm diameter. A comparable difference in bead size then defines spacing of detents D at incremental distances along strand 16, giving the tea-preparer a number of fixed positions for more easily resting the fold of the strand at the lip of the cup or teapot.

Weighting member 18, suspended outside the teacup as a type of “counterweight” as shown in FIGS. 2 and 3, compensates for the combined weight of the immersed tea bag or bags and those inner-cup portions of strand 16 that lie on the other side of the detent formed along the folding lip of the vessel. Weighting member 18 is formed of a material having sufficient weight and suitable dimensions for supporting the filter bag T that is clasped at the opposite, clamping member 12 end. In practice, weighting member 18, with any supporting hardware or attachments, should exceed clamping member 12 in weight. According to an exemplary embodiment, the weight of weighting member 12 exceeds twice the average weight of the beads 14 in strand 16. The size or volume of weighting member 12 exceeds twice the average volume of the beads 14 in strand 16. Without limitation, and by way of example only, typical weights for weighting member 18 can be in the 4-6 gram range.

The invention has been described in detail with particular reference to one or more advantaged embodiments, but it will be understood that variations and modifications can be effected within the spirit and scope of the invention. The presently disclosed embodiments are therefore considered in all respects to be illustrative and not restrictive.

1. An apparatus for steeping tea in a vessel, comprising:
(a) a clamping member that is configured to releasably grasp an edge of a tea filter bag;
(b) a weighting member weighing more than the clamping member; and
(c) a strand of beads having a first end coupled to the clamping member and a second end, opposite the first end, coupled to the weighting member,
the strand of beads having a plurality of beads joined to each other by a metal linkage, wherein the strand of beads is configured to fold over a lip of the vessel to provide at least a first detent position for supporting the tea filter bag at a first immersion distance from the fold lip, and a second detent position for supporting the tea filter bag at a second immersion distance from the fold lip.

2. The apparatus of claim 1 wherein the clamping member is an alligator clip.

3. The apparatus of claim 1 wherein the beads are formed from glass.

4. The apparatus of claim 1 wherein the clamping member is coupled to the strand of beads with a metal linkage.

5. The apparatus of claim 1 wherein the strand has seed beads of a first width dimension and positioned between larger beads having a second width dimension that is at least 1.5 times the first width dimension.

6. The apparatus of claim 5 wherein the first detent position is defined at a seed bead position.

7. The apparatus of claim 1 wherein the first detent position is defined between two adjacent beads.

8. An apparatus for steeping tea in a vessel, comprising:
(a) at least one clamping member that is configured to releasably grasp an edge of one or more tea filter bags;
(b) a strand of beads having a first end that is coupled to the clamping member; and
(c) a weighting member that is coupled to a second end of the strand of beads,
wherein the weight of the weighting member exceeds twice the averaged size and weight of beads in the strand of beads;
wherein the strand of beads is configured to fold over a lip of the vessel to provide at least:
(i) a first detent position between a first pair of beads for supporting the tea filter bag at a first immersion distance from the fold, and
(ii) a second detent position between a second pair of beads for supporting the tea filter bag at a second immersion distance from the fold.

9. The apparatus of claim 8 wherein the at least one clamping member is formed of metal.

10. The apparatus of claim 8 wherein beads in the strand are coupled to each other using wire.

11. A method comprising:
(a) providing a releasable metal clamping member configured for grasping a tea filter bag;
(b) coupling the releasable metal clamping member to a first end of a strand of beads,
wherein the strand of beads has a plurality of beads joined to each other by a metal linkage,
wherein the strand of beads is configured to fold over a lip of a drinking vessel to suspend the releasable metal clamping member within the drinking vessel at at least a first detent position for supporting the tea filter bag at a first immersion distance from the fold lip, and a second detent position for supporting the tea filter bag at a second immersion distance from the fold lip; and
(c) coupling a weighting member, weighing more than the clamping member, to a second end of the strand of beads, opposite the first end, wherein the weighting member is configured for suspension outside the drinking vessel.
